(19) United States
(12) Patent Application Publication
(10) Pub. No.: US 2006/0200542 A1
(43) Pub. Date: Sep. 7, 2006

(54) Apparatus and method for network-aware power management

(75) Inventor: Randy C. Willig, Fort Collins, CO (US)

Correspondence Address: HUFFMAN LAW GROUP, P.C., 1832 N. CASCADE AVE., COLORADO SPRINGS, CO, 80907-7449, US

(73) Assignee: Tendril Networks, Inc., Boulder, CO (US)

(21) Appl. No.: 11/364,585

(22) Filed: Feb. 28, 2006

Related U.S. Application Data
(60) Provisional application No. 60/657,160, filed on Feb. 28, 2005.

(51) Int. Cl. G06F 15/173

(52) U.S. Cl. 709/223; 370/311

(57) ABSTRACT

Apparatus and methods managing the power profile of a network of interconnected devices. In one embodiment, an apparatus is provided for managing the power consumed by a network of devices. The apparatus includes power management logic that is disposed within a plurality of the devices in the network. The power management logic provides for network-aware power management of the network of devices. The power management logic has descriptor data and management data. The descriptor data identifies a power source for a corresponding device in the network. The management data identifies a function for remote execution by one or more other devices in the network.

### CROSS-REFERENCE TO RELATED APPLICATIONS

This application claims the benefit of the U.S. Provisional Application Ser. No. 60/657,160 (Docket: TDNW.0101), filed on Feb. 28, 2005, which is herein incorporated by reference for all intents and purposes.

### BACKGROUND OF THE INVENTION

1. Field of the Invention

This invention relates in general to the field of transducer networks, and more particularly to apparatus and methods for managing power across a network of interconnected devices.

2. Description of the Related Art

Networks consisting of hundreds of interconnected transducer devices are now being employed in many areas of application. These networks, also referred to in the art as “sensor networks,” are used in factory, industrial, and other settings to monitor parameters such as stress, vibration, pressures, temperature, humidity, turbidity, movement, etc. For example, a sensor network may be deployed to monitor the structural integrity of pipelines and structures in, say, a drilling rig, or a bridge, or a skyscraper. In addition, sensor networks are now being employed to monitor and secure inventory in, say, a department store setting.

Sensor networks can include devices that are interconnected via wires or devices that utilize a wireless connection medium. Wired network types vary from proprietary interconnection schemes to the convention TCP/IP over Ethernet means of communication. Wireless networks are just presently being fielded. A wireless network typically consists of some number of very low-power, low-data rate transducers, generally interconnected in a mesh configuration. The transducers themselves typically are sensing or control devices coupled to a microcontroller and low-power transceiver via embedded firmware in the microcontroller. Such a transducer configuration is generally referred to as a “device” or “node.” And the interconnection medium between these devices is about the only attribute that they have in common.

Even though a device may perform the same function (e.g., temperature sensing) as another device on a network, its manufacture may be completely different. The device is perhaps programmed differently, it may have a different source of power (e.g., solar power versus AC power), and it may furthermore have the capability to perform additional processing over that required to perform its primary function.

Consequently, creating applications for large, diverse sensor networks is difficult at best due to the sheer volume heterogeneous devices, and the varying longevity and dynamics of the devices. When node volume and node diversity increases, the complexity of the entire system increases exponentially. One skilled in the art will appreciate that while standards such as ZIGBEE™ address the need for an industry-driven open standard, they don't define the tools required to build these systems, nor do these standards provide solutions that allow for system level visibility and control.

As a result, developers of large sensor networks face investing dozens of man-years into developing common “foundational” software services that are unrelated to the application they seek to build. They are forced to develop application code to provide services that, among other requirements of the network, accesses groups of sensor nodes and manages data corresponding to the groups.

The present inventor has noted limitations and problems associated with current device networking technologies that preclude optimum performance. More specifically, the present inventor has observed that the present art lacks any techniques that allow for reducing the power consumption of networked devices short of simply turning devices off or putting them into a “low-power” mode. This type of power management actually decreases the performance of a system composed of a network of interconnected devices.

Many devices have an inherent limitation on the amount of power they can consume in order to accomplish a function. Beyond the power necessary to provide a function on a device, it is also frequently necessary to transmit information across a network. The act of transmitting the information consumes power as well, complicating the power consumption needs of the device. In addition, the power available to each device varies due to the constraints of the device's power source. Consequently, the present inventor has observed that if the devices in a network are able to share information about their instantaneous power profile, as well as being aware of the power model of data propagation within the network itself, it is desirable to utilize this information to manage the overall power profile of the network, thus realizing a large improvement in system wide power efficiency.

### SUMMARY OF THE INVENTION

The present invention, among other applications, is directed to solving the above-noted problems and addresses other problems, disadvantages, and limitations of the prior art. The present invention provides superior techniques for managing the power profile of a network of interconnected devices. In one embodiment, an apparatus is provided for managing the power consumed by a network of devices. The apparatus includes power management logic that is disposed within a plurality of the devices in the network. The power management logic provides for network-aware power management of the network of devices. The power management logic has descriptor data and management data. The descriptor data identifies a power source for a corresponding device in the network. The management data identifies a function for remote execution by one or more other devices in the network.

One embodiment of the present invention contemplates a network of wireless devices. Another embodiment considers a combined wired/wireless network of devices. A brokered embodiment comprehends power management performed by a service broker device.

One aspect of the present invention contemplates a power management mechanism, for controlling the power consumed by devices within a network. The power management mechanism has power status logic and remote control logic. The power status logic is disposed within each of a plurality of the devices and is configured to evaluate power status data for a corresponding device. The remote control logic is also disposed within the each of said plurality of the devices and is coupled to the power status logic. The remote control logic is configured to export or import functions as directed.

Another aspect of the present invention comprehends power management apparatus, for managing the power consumed by a network of devices. The power management apparatus includes first power management logic that is disposed within a service broker device, where the service broker device is one of a plurality of the devices in the network. The service broker device provides for network-aware power management of the network of devices. The power management logic has descriptor data and management data. The descriptor data is received over the network, and identifies a power source for each of the plurality of devices in the network. The management data is provided for transmission over the network and identifies one or more functions for remote execution by one or more other devices in the network. The service broker device transmits messages over the network to distribute the one or more functions to the one or more other devices, thereby managing the power consumed.

A further feature of the present invention considers a method for exporting functions to optimize a power profile of a network of devices. The method includes, within each of a plurality of devices coupled to the network, evaluating a local power status and determining whether sufficient power is available to perform local functions; for a first one of the plurality of devices, broadcasting a message over the network that indicates functions available for export; determining that a second one of the plurality of devices can perform one or more of the functions; and exporting the one or more of the functions for execution by the second one of the plurality of devices.

Yet another aspect of the present invention contemplates a method for importing functions to optimize a power profile of a network of devices. The method includes monitoring messages broadcast over the network to determine if one or more devices have insufficient power to perform certain functions; evaluating a local power status and determining whether sufficient power and processing capabilities are available to perform the certain functions; and in a destination device, importing one or more of the certain functions for execution.

### BRIEF DESCRIPTION OF THE DRAWINGS

These and other objects, features, and advantages of the present invention will become better understood with regard to the following description, and accompanying drawings where:

FIG. 1 is a block diagram illustrating an exemplary present day network of heterogeneous devices;

FIG. 2 is a block diagram depicting a network-aware power management configuration according to the present invention;

FIG. 3 is a block diagram featuring an exemplary power descriptor according to the configuration of FIG. 2;

FIG. 4 is a block diagram showing an exemplary power management message format according to the present invention;

FIG. 5 is a block diagram illustrating an exemplary network-aware device according to the present invention;

FIG. 6 is a flow chart detailing a method according to the present invention for exporting functions in order to optimize a network's power profile; and

FIG. 7 is a flow chart illustrating a method according to the present invention for importing functions from a network-aware device.

### DETAILED DESCRIPTION

The following description is presented to enable one of ordinary skill in the art to make and use the present invention as provided within the context of a particular application and its requirements. Various modifications to the preferred embodiment will, however, be apparent to one skilled in the art, and the general principles defined herein may be applied to other embodiments. Therefore, the present invention is not intended to be limited to the particular embodiments shown and described herein, but is to be accorded the widest scope consistent with the principles and novel features herein disclosed.

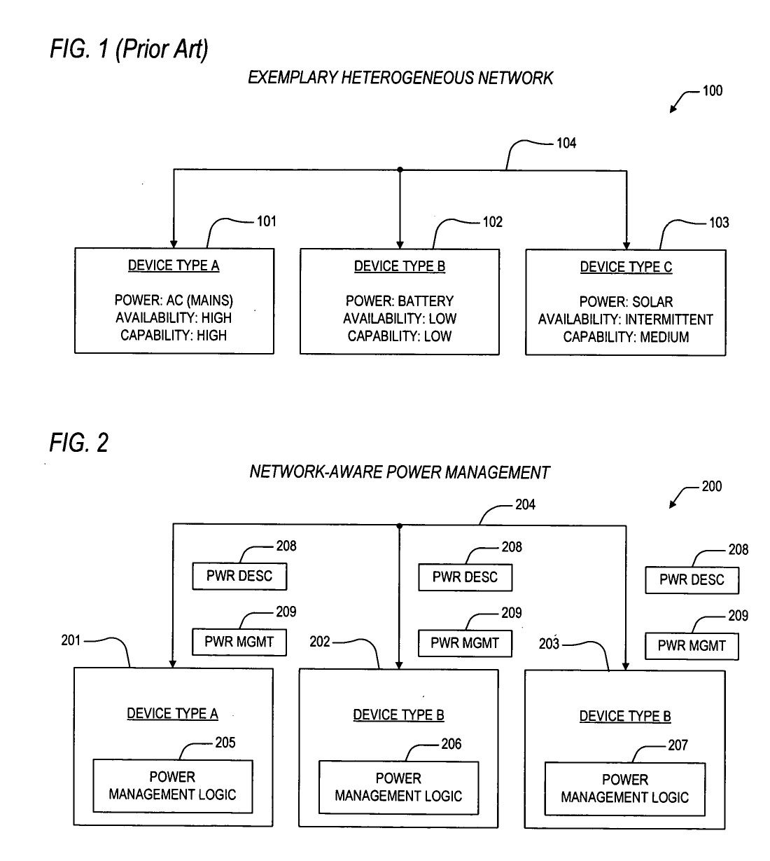

In view of the above background discussion on transducer networks and present day techniques which are employed therein to perform power management functions, a discussion of the limitations of such techniques will now be presented with reference to FIG. 1. Following this, a discussion of the present invention will presented with reference to FIGS. 2-7. In contrast to present day power management techniques, the present invention enables transducers within a network to express power availability and functional requirements within the network as a set of network available meta-properties, so that the networked system is enabled to intelligently allocate and control the power consumed by the system.

Referring to FIG. 1, a block diagram is presented illustrating an exemplary present day network 100 of heterogeneous devices 101-103. For purposes of illustration, the devices 101-103 are coupled together via a networking medium 104, but each of the devices 101-103 are different in some aspect. For instance, all three devices 101-103 may be sensor devices 101-103, but they are produced by different manufacturers and as a result, have different requirements for setup, programming, and etc. Alternatively, the devices 101-103 could be produced by the same manufacturer and have similar programming requirements, but they form part of a heterogeneous network 100 because they are different types of transducers. In a broad sense consistent with the scope of this application, a heterogeneous network 100 comprises one or more devices 101-103 coupled together via one or more different network mediums 104, which are required to function together for purposes of achieving an overall system function. Hereinafter, the term “sensor” 101-103 may be employed to refer to a transducer device 101-103, but the functional scope of the device should not be restricted to a sensing function. Rather, a sensor 101-103 in sense used herein may be employed as an output of the network 100 (e.g., an audio speaker, a radiating element, an emitting device, a control valve, a flashing light) as well.

Heterogeneous networks 100 consisting of hundreds, or even thousands of transducers 101-103 are being fielded in increasing numbers. To illustrate, consider an application where a sensor network 100 is employed within a large cargo ship to detect all sorts of environmental data (e.g., a sensing function) and to control various equipment (e.g., a controlling function). The network 100 comprises hundreds of highly constrained sensor and control nodes 101-103. In this application, exemplary sensors 101-103 include vibration and stress-sensing sensors 101-103 attached to the hull of the ship to monitor structural parameters; temperature sensors 101-103 on equipment in the ship's engine room; temperature and humidity sensors 101-103 connected throughout the ship to check overall conditions for both personnel and equipment; and accelerometers 101-103 attached to the hull to detect normal and extreme movements. In addition, transducers 101-103 such as fan controls 101-103 are provided to monitor the ship's ventilation system; motor and valve controls 101-103 are attached to engine room equipment and equipment in other machine rooms; fuel and energy supply valve controls 101-103 are employed restrict fuel flow in case of dangerous conditions; and radio frequency identification (RFID) and other tracking sensors 101-103 are provided on each cargo container to monitor movement, internal/external temperature, and to detect tampering.

The above example illustrates the extremely diverse nature of a present day heterogeneous sensor network 100, a portion of which is illustrated in the block diagram of FIG. 1. Now, to focus attention on the limitations of a conventional heterogeneous network 100, consider a meteorological application, where device A 101 is embodied as an anemometer, device B 102 is a rain gauge, and device C 103 is a temperature sensor. The devices 101-103 may be provided power from one or more types of power sources including, but not limited to, AC (mains), AC (generator), battery, and solar source. Device A 101 is powered by AC (mains), and is thus highly available for use. In addition, device A 101 is highly capable of performing its function (e.g., sensing wind speed), plus perhaps other functions as well (e.g., sensing wind direction, or temperature, or humidity). Device B 102 is shown to be powered by battery and thus exhibits a low availability to the network 100. In addition, device B 102 has low capabilities to perform other functions. Device C 103 is solar powered and thus exhibits an intermittent availability to function. Also, device C 103 has a medium capability to perform other functions besides that allocated.

The devices 101-103 are interconnected through a network medium 104. Examples of networking mediums 104 include, but should not be restricted to, local area networking media 104 such as Ethernet, short distance networking media 104 such as BLUETOOTH®, IEEE 802.11 wireless network media 104, and small sensor network media 104 such as ZIGBEE™ and proprietary network media 104 performing substantially similar function. Each of the devices 101-103 in this example are configured to manage power in an isolated fashion, that is, in complete isolation to power concerns of other devices 101-103 in the network 100 or of the network medium 104, or of transport mechanisms across the network medium 104. Since each of the devices 101-103 do not maintain any understanding of the power capabilities or restrictions of the other devices 101-103 in the network 100, there is no system-wide power usage coordination. Hence, the devices 101-103 provide for a few, simplistic power states such as ON, SLEEP, and SUSPEND. Power state control may be more granular at the level of a device 101-103, such as that exhibited by present day laptop computers, but it is noted that a present day heterogeneous network 100 is limited in the sense that no single device 101-103 is aware of, or is capable of controlling the power consumed by another device 101-103 on the network 100.

The present inventor has observed that the inability to effectively and efficiently sense and control the power consumed by the devices 101-103 comprising a heterogeneous network 100, from a network-wide perspective, significantly limits the overall performance of the corresponding system 100. It has been further noted that it is desirable to manage the power consumed by the devices from a system-level perspective, to increase the overall performance of the networked system 100.

As alluded to above, there have been attempts in the art to work around the power management limitations of heterogeneous networks 100. For example, in U.S. Pat. No. 6,028,857, Poor discloses a self-organizing wireless network. The network consists of a plurality of nodes (e.g., devices 101-103), each of which is configured to originate messages, to be a destination of messages, and to relay messages. The messages are transmitted in a frame that includes the cost of conveying the message to a destination node. Also included in the frame is the cost so far expended in conveying the message. Consequently, each time a message frame is transmitted, either by an originating node or by a relaying node, the node ascertains whether the cost to convey the message from that node to the destination node is less than the conveying cost contained in the received frame. If it is, then the node retransmits the frame after having incremented the incurred cost by the relay cost of that node and decremented the cost to convey by the same value. Otherwise the node discards the message.

Poor's network indeed provides for limiting the amount of power consumed which is associated to transmission of a single message. Such a mechanism is useful to control the cost of network communications over a wireless network, but Poor does not address any form of communications that enable one or more nodes 101-103 to become aware of the limitations of other nodes 101-103 from a power consumption, availability, or capability perspective, nor does he provide any sort of motivation that would lead one skilled in the art to implement any sort of technique which would improve overall system performance by managing the power consumed, or functions performed, by one or more devices 101-103 on the network.

In addition, the present inventor, in U.S. Pat. No. 6,684,339, teaches a technique for transferring information from a first device 101-103 to a second device 101-103 when the first device 101-103 goes under a reduced power mode. Accordingly, the technique is employed in a system comprising a plurality of devices 101-103 that are connected together in a network 100. The patent discloses a system and method of transferring information from the first device 101-103 in the network 100 to the second device 101-103 when the first device is operating in the reduced power mode. The first device 101-103 as a second power supply for supplying power to the first device 101-103 when a first power supply fails. The first device 101-103 also has a controller for transferring information from the first device to a second device 101-103 over the network 104 when the first device 101-103 is receiving power from the second power supply. The second device 101-103 receives the information that has been transferred from the first device 101-103 over the network 104.

Although information is transferred from one device 101-103 to the next, the invention of U.S. Pat. No. 6,684,339 does not address, or even allude to, proactive management of the functions of a networked system 100 based upon a top-level consideration of power consumption. Rather, the invention provides for a reactive, fallback mode of operation, whereby a given sensor 101-103 offloads its collected data to another sensor 101-103 when the given sensor experiences a failure of its primary power supply. The offload of data is accomplished using a secondary, or backup, power supply.

The two above-noted disclosures, along with other teachings in the related art, are lacking the ability to enable a network 100 of perhaps thousands of heterogeneous devices 101-103 to exhibit increased or enhance performance (e.g., availability of system function) because the power consumed and/or functions performed by particular devices 101-103 is noted and controlled over the network medium 104. The present inventor has noted that prior art methods of system design cannot affect power management at a system level. Power management is only modifiable at the device level, and in addition the power can only be managed in a few, discrete number of power states. It is furthermore noted that most present day commercial and academic research on network level power management focuses on transport efficiency, synchronized transmission/reception times, and optimized routing protocols, as is exemplified by the teachings of U.S. Pat. No. 6,028,857, discussed above. These conventional design techniques do not consider the varied power models of devices 101-103 across the network 100, and there is furthermore no mechanism in place for devices 101-103 to cooperate in order to achieve effective system-wide power/performance management.

The present invention overcomes the above noted problems in the art, and others, by providing a comprehensive, dynamic, system-wide power management solution. In contrast to present day power management techniques, which are based on discrete devices having a limited number of power states that support a device-level operating profile without any awareness of the operation of other devices in a network, the present invention provides apparatus and methods for devices to proactively manage power consumption and performance at network level. The present invention provides techniques that enable a system to shift power usage (i.e., consumption) to a more appropriate location, a different time, or to more capable device. As will be described hereinbelow with reference to FIGS. 2-7, the present invention enables devices within a heterogeneous network to express power availability and functional requirements within the network as a set of network available meta-properties, so that the networked system is enabled to intelligently allocate and control the power consumed by the system. These meta-properties expose the power consumption properties of devices within a network, as well as the properties of the network medium, in order to enable an awareness of, and subsequent intelligent management of, the power utilization of those networked devices.

Turning now to FIG. 2, a block diagram is presented showing a network-aware power management configuration 200 according to the present invention. The configuration 200 includes network-aware devices 201-203 that each include respective power management logic 205-207. Like those devices 101-103 discussed with reference to FIG. 1, network-aware devices 201-203 according to the present invention may be embodied as any type of device 201-203 that is currently networked or that may be contemplated for networking in the future over any network medium 204 including, but not limited to, devices 201-203 such as switches, transducers, sensors, routers, controllers, monitors, and the like. For example, the devices 201-203 may be sensing devices 201-203 (e.g., temperature, light, power, pressure, x-ray, and etc.), control devices 201-203 (e.g., desktop computer, laptop computer, industrial controller, mainframe computer, microcontroller, ASIC, router, gateway, etc.), or they may be software or firmware components 201-203 (e.g., application programs, operating systems, shells) existing within other devices (e.g., a remote computer). Furthermore, the devices 201-203 according to the present invention may be provided power from one or more types of power sources including, but not limited to, AC (mains), AC (generator), battery, and solar source.

In contrast to present day devices 101-103, the devices 201-203 according to the present invention provide for network-aware power and performance management through the employment of power descriptor data 208 and power management data 209 that is communicated to the other networked devices 201-203 according to the particular communications protocol commensurate with the network medium 204. The descriptor data 208 allows for determination of current power status from a network-wide perspective, and supports options for power reduction that include the transfer of one or more functions from one or more of the devices 201-203 to other devices 201-203 that are more power consumption efficient at the time or transfer. The management data 209 supports implementation of selected ones of the options by providing for transfer of selected functions. In one embodiment, one or more of the devices 201-203 is embodied as a control device 201-203 which is capable of performing network power and performance management functions, as will be described in further detail below. In alternative embodiments, one or more of the devices 201-203 are embodied as transducers disposed within computing elements capable of communicating over the network medium according to the particular network protocol employed. In one embodiment, the computing elements comprise microcontrollers or microprocessors and associated memory and interface logic. Other discrete and analog embodiments are contemplated as well.

An embodiment of a control device 201-203 comprehends a computing device coupled to the network medium 204 providing web services (to include web service distributed management functions) related to performance of the functions required by the system 200. In one embodiment, the web services comport with standard application developer paradigms (e.g., such as are useful to a JAVA™, .NET, or C++ developer) and be easily integrated into popular development environments such as Eclipse, INTELLIJ™, or MICROSOFT VISUAL® .NET. Alternatively, the web services are embodied as a set of libraries and tools with a run-time engine that is disposed on a computing device. It is noted that web services are also known as “service brokers” and these brokers serve as structured mechanisms to coordinate communications, such as forwarding requests from a node (e.g., device) 201-203 to a corresponding application program, providing for communications from node 201-203 to node 201-203. In one embodiment, a service broker device 201-203 is contemplated that provides for communications between ZIGBEE-based wireless nodes 201-203.

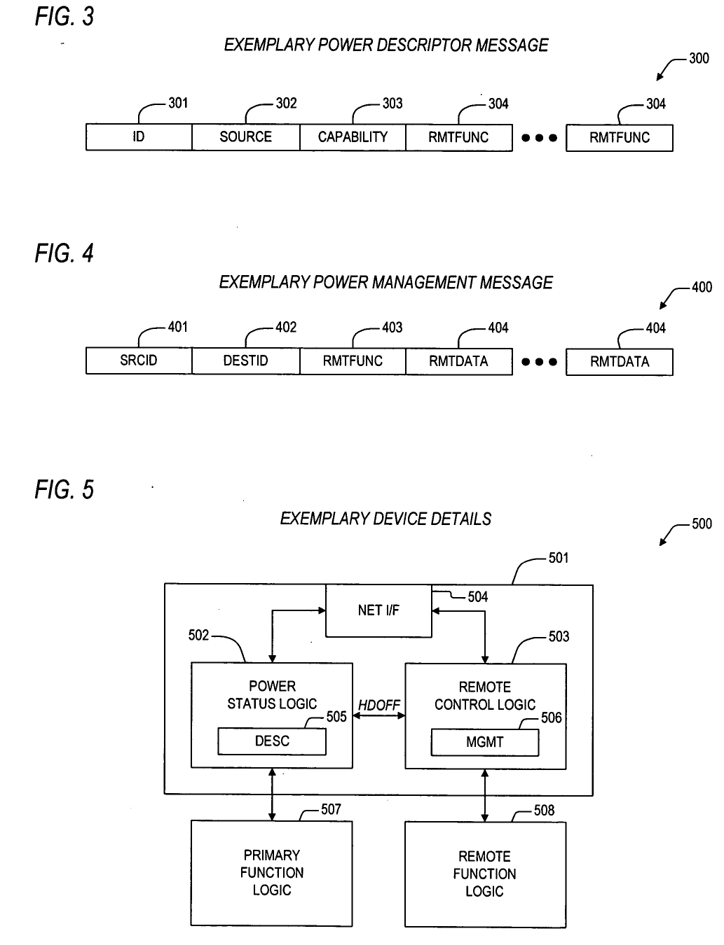

Now referring to FIG. 3, a block diagram is presented featuring an exemplary power descriptor 300 as discussed with reference to FIG. 2. The power descriptor 300 is generated and maintained by the power management logic 205-207 within each of the networked devices 201-203 to enable coordination of power utilization across the network 204. By employing power descriptors 300, each networked device 201-203 can evaluate how best to utilize the power available for accomplishment of functions from the perspective of power consumption of the network as a whole. In one embodiment, evaluation of the network-level power consumption can be performed by the devices themselves 201-203. In an alternative embodiment, network-level power consumption evaluations are performed by an external power-aware controlling device (not shown). In a further embodiment, one or more of the devices 201-203 function as a control device 201-203 as described above and accomplish the power evaluations and direct the transfer/distribution of functions between devices 201-203 within the network 200. It should be noted that these simple descriptors 300 enable more than just the ability to change operating states. Since each device has access to the descriptors of devices throughout the network, intelligent choices can be made about routing, data aggregation, and network transport reliability. For instance, one embodiment of the present invention contemplates a descriptor 300 which is employed to manage the routing of packets between devices according to the present invention.

The exemplary power descriptor 300 includes an ID field 301, a SOURCE field 302, a CAPABILITY field 303, and one or more RMTFUNC fields 304. The ID field 301 comprises data that identifies the particular device 201-203. The SOURCE field 302 comprises data that identifies a power source (e.g., battery, solar, AC (mains), etc.) that provides power for the device 201-203. The CAPABILITY field 303 comprises data that identifies and quantifies excess processing capabilities of the device 201-203 for purposes of importing functions from other devices 201-203 in order to reduce or optimize network-wide power consumption. The RMTFUNC field 304 comprises data that identifies functions of the device 201-203 that can be exported to other devices for above noted purposes. In an intelligent routing embodiment, fields 303 and 304 identify packet routing functions which can be imported and exported by a device according to the present invention.

For example, consider that device A 201 has access to AC (mains), which provides steady, reliable power. This power source in one embodiment can be viewed as the best power source, if reliability and capacity are the primary evaluation criteria for network-wide power consumption. If, however, the cost of the AC power source is high, it may be less preferable during times that solar power is available. Consider that device B 202 is battery powered, and therefore has a small, reliable, continuous source of power. Although limited in lifespan, battery power can be more reliable than an external source. Yet since the battery power is limited, device B 202 will most likely export all possible functions whenever the capability exists elsewhere on the network to execute those functions. Additionally, network routing tables should only list battery powered devices 202 for secondary routes, since the power is always limited. Further, consider that device C 203 is solar powered. During periods of unobstructed daylight, device C 203 should have sufficient capacity to provide local functionality, that is, to execute its required functions. And since solar generation is a fixed, long term cost, it may be considered the best, lowest cost source when available. Accordingly, in a system configuration 200 according to the present invention, processes (e.g., functions) could be migrated to this device C 203 type during mid day, when excess capacity is available. And a solar-powered device 203 could be the primary network router during periods of excess capacity. Periods of no power (darkness) would cause the network 200 to re-route functions from the solar-powered device 203 to other available devices 201-202. In an embodiment directed towards packet routing, the routing functions would perhaps be migrated to the solar-powered device 203 during mid day, and would be re-routed to other devices 201-202 during darkness.

Turning to FIG. 4, a block diagram is presented showing an exemplary power management message 400 according to the present invention. For clarity, the power management message 400 is provided as a separate item for discussion, however, one skilled in the art will appreciate that the fields 401-404 provided therein could be provided as part of the power descriptor 300 or could be provided stand alone. It is sufficient for purposes of the present invention that the information contained within the fields 301-304, 401-404 is communicated or otherwise provided across the network 200; the manner and format in which the information is provided is configuration- and network medium-dependent.

The exemplary power management message 400 includes a SRCID field 401, a DESTID field 402, a RMTFUNC field 403, and one or more RMTDATA fields 404. The SRCID field identifies a device 201-203 that is exporting a function for remote execution which is identified by the RMTFUNC field 403. These functions could encompass essential sensing and control functions, extended functions such as data aggregation (e.g., averaging, integration, monitoring limits, etc). In addition to local processing, devices 201-203 with sufficient capabilities (and with power descriptors 400 signifying these capabilities) can also perform functions for other devices 201-203 in the network that have a less adequate power source. The DESTID field 402 comprises data that identifies a device 201-203 that is importing the function for execution therein. And the one or more RMTDATA fields 404 comprise optional data (e.g., conversion factors, rate tables, etc.) that is required to perform the identified function. In the case where functions are to be advertised for remote execution, the RMTDATA fields 404 would support encapsulation of the functions such that they can migrate to more capable devices. These functions, as well as the needed data, would utilize an encapsulation system that would sufficiently describe the power required to perform the function. Hence, in one embodiment, network-wide power state and capabilities are observed through the employment of the power descriptors 300. Distribution of functions (and commensurate power properties) is accomplished via the power management messages 400.

FIG. 5 depicts a typical network-aware device 500, like those 201-203 shown and discussed with reference to FIGS. 2-4. The device 500 includes power management logic 501 that is coupled to primary function logic 507 and remote function logic 508. The power management logic, in one embodiment, includes a network interface 504 that is coupled to a network medium (not shown) and that couples to power status logic 502 and remote control logic 503. The power status logic 502 generates and maintains a power descriptor DESC 505 that corresponds to the device 500 and the remote control logic 503 is responsible for the maintenance and processing of power management messages and for generating and maintaining a management descriptor MGMT 506. In one embodiment, the power descriptor 505 contains substantially the same data as the exemplary power descriptor 300 of FIG. 3 and the management descriptor 506 contains substantially the same data ass the exemplary management descriptor 400 of FIG. 4.

In operation, the power status logic 502 evaluates the primary function logic 507 and power status data corresponding to the remote function logic 508 as provided via a handoff bus HDOFF, and generates and provides the DESC 505 to the network interface 504 according to the timing requirements of the system network for purposes of power management. In one embodiment, the remote control logic 503 receives power management messages 506 and exports/imports identified functions as directed therein, and provides imported functions to the remote function logic 508 for execution. Alternatively, the remote control logic receives power management messages 506 from other devices within the network and determines which functions to distribute to the networked devices, and thus generates power management messages 506 to the network interface 504 to distribute selected functions. If any local functions are exported, such information is provided via bus HDOFF to the power status logic 502, which directs the primary function logic 507 to cease performing the exported functions.

The power status logic 502 comprises logic, circuits, devices, or software, or a combination of logic, circuits, devices, or software, or equivalent elements that are employed to evaluate the primary function logic 507 and power status data corresponding to the remote function logic 508. The elements employed by the power status logic 502 to perform these functions may be shared with other circuits, software, etc., that are employed to perform other functions within the device 500. In addition, the remote control logic 506 comprises logic, circuits, devices, or software, or a combination of logic, circuits, devices, or software, or equivalent elements that are employed to receive power management messages 506 and export/import identified functions as directed therein, and to provide imported functions to the remote function logic 508 for execution. The elements employed by the remote control logic 506 to perform these functions may be shared with other circuits, software, etc., that are employed to perform other functions within the device 500. In substantially the same manner, the primary function logic 507 and remote function logic 508 comprise logic, circuits, devices, or software, or a combination of logic, circuits, devices, or software, or equivalent elements that are employed to perform the above noted functions. The elements employed to perform these functions may be shared with other circuits, software, etc., that are employed to perform other functions within the device 500.

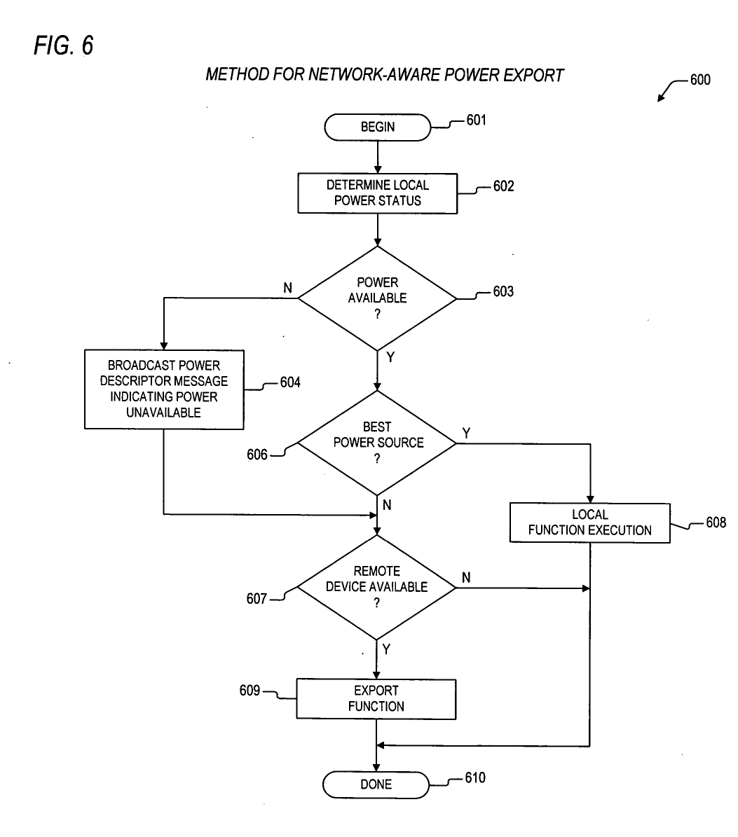

Now referring to FIG. 6, a flow chart is presented illustrating a method according to the present invention for exporting functions in order to optimize a network's power profile. Flow begins at block 601 where a device according to the present invention begins a power evaluation. Flow then proceeds to block 602 where power management logic therein determines within the given device it's local power status (e.g., power source, capacity, exportable functions, etc.). Flow then proceeds to decision block 603 where a determination is made whether sufficient power is available to perform local functions. If so, then flow proceeds to decision block 606. If not, then flow proceeds to block 604.

At block 604, since insufficient power is available to perform local functions, a power descriptor message is broadcast to the network indicated that power is unavailable. Flow then proceeds to block 607.

At block 606, a determination is made concerning whether the local power source is indeed the best power source for performing local functions in view of network-wide resources and constraints. If so, then flow proceeds to block 608. If the local power source is not the best power source, then flow proceeds to decision block 607.

At decision block 607, an evaluation is made to determine if another device is available over the network which can perform selected functions. If not, then flow proceeds to block 610. If so, then flow proceeds to block 609.

At block 608, the functions are maintained and executed locally by the particular device. Flow then proceeds to block 610.

At block 609, one or more functions, as determined via decision blocks 603, 606, and 607, are exported to one or more devices on the network for remote execution. Flow then proceeds to block 610.

At block 610, the method completes.

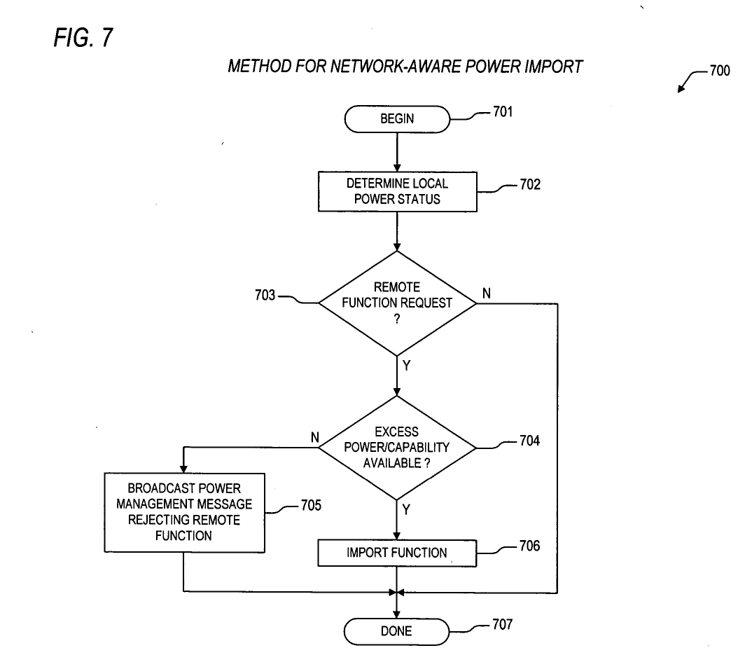

Turning now to FIG. 7, a flow chart 700 is presented highlighting a method according to the present invention for importing functions from a network-aware device. Flow begins at block 701 where a device according to the present invention is provided in the context of a power-managed network. Flow then proceeds to block 702, where local power status is determined. Flow then proceeds to decision block 703.

At decision block 703, an evaluation is made to determine if a power management message has been received that requests that the particular device perform a function remotely. In one embodiment, the particular device monitors messages that are broadcast over the power-managed network by other devices to determine if one or more of the other devices has insufficient power and/or processing capabilities to perform local functions. Thus, a power management message is explicitly or implicitly received by the particular device. If a power management message is received, then flow proceeds to decision block 704. If a power management message is not received, then flow proceeds to block 707.

At decision block 704, the device determines if sufficient excess power and processing capability is available to perform the requested function. If so, then flow proceeds to block 706. If not, then flow proceeds to block 705.

At block 705, since insufficient excess power and/or insufficient excess processing capability is available to perform the requested remote function, the device generates and broadcasts a power management message rejecting the remote function. In one embodiment, the message designates another device on the network. Alternatively, the message is provided to one or more controllers on the network. In a further embodiment, rejection is accomplished by not responding. Flow then proceeds to block 707.

At block 706, the remote function is imported and the device executes the remote function until such time as the network directs otherwise. Flow then proceeds to block

At block 707, the method completes.

As disclosed above, the present invention enables the power properties of each device, component, and function within a network of devices to be quantified. Apparatus and methods are provided to define the power requirements of participation in the network and additionally to define the power requirements of associated transport mechanisms. These defined properties are available to each of the devices on the network, so that power decisions are made from a system-wide perspective as opposed to a device-level perspective. Devices according to the present invention support a cooperative system-wide power management strategy though the ability to dynamically migrate process functions to more power-capable devices, to optimize routing through lowest power paths, and to schedule power use coincident with power availability.

The present invention can be employed in any system configuration that contemplates a network of power-constrained/process-constrained devices, as well as in any other configuration where it is desirable to manage overall power consumption. The present invention is network medium and device agnostic, and has the advantage of reducing power consumption from both a device level and system level perspective. Moreover, the present invention is configured to utilize power from the most appropriate power source such that that processing is intelligently moved among/between different power sources over the network.

Although the present invention and its objects, features, and advantages have been described in detail, other embodiments are contemplated by the present invention as well. For example, the present invention has been characterized in part in terms of a network of low-power wireless sensors and transducers. Such networks certainly can benefit from the capabilities afforded by the present invention. But the scope of the present invention should not be constrained to wireless network applications. Rather, it is noted that the present invention comprehends networks that are hard-wired as well, such as, but not limited to, industrial automation networks, building maintenance (e.g., automated lighting, HVAC, etc.), and networks of interconnected computers and computing devices. Likewise, the present invention contemplates a combination of network topologies such as a network of wireless transducers deployed remotely that are accessed via a wireless node having connection to the Internet via any number of connection means, where control of the power consumption and function distribution of the wireless devices is affected by one or more service broker devices that are coupled to the Internet and operating at a location removed from the location where the sensor network is deployed.

In addition, though the present invention has been disclosed particularly with reference to power descriptors corresponding management of power and functions for devices to enabled system-wide power management of a network of devices, the scope of the present invention should not be limited to such functions. It is noted that the present invention also contemplates that transducer devices will improves to the extent that a more robust set of descriptors can be provided to enable the additional management of other system attributes including, but not limited to, bandwidth, thermal and electromagnetic signatures, and operational cost.

Those skilled in the art should appreciate that they can readily use the disclosed conception and specific embodiments as a basis for designing or modifying other structures for carrying out the same purposes of the present invention, and that various changes, substitutions and alterations can be made herein without departing from the scope of the invention as defined by the appended claims.

What is claimed is:

1. An apparatus for managing the power consumed by a network of devices, the apparatus comprising:
power management logic, disposed within a plurality of the devices in the network, configured to provide for network-aware power management of the network of devices, said power management logic comprising:
descriptor data, said descriptor data identifying a power source for a corresponding device in the network; and
management data, said management data identifying a function for remote execution by one or more other devices in the network.

2. The apparatus as recited in claim 1, wherein the network comprises a wireless network.

3. The apparatus as recited in claim 2, wherein the network is configured according to ZIGBEE standards.

4. The apparatus as recited in claim 1, wherein the network comprises a combination of wired and wireless devices.

5. The apparatus as recited in claim 1, wherein one or more of the devices comprises a service broker.

6. The apparatus as recited in claim 5, wherein said service broker transmits a management message directing a destination device to perform said function, and wherein said management message comprises a portion of said management data.

7. The apparatus as recited in claim 1, wherein said power management logic disposed within a destination device enables said destination device to import said function for execution.

8. The apparatus as recited in claim 1, wherein said descriptor data comprises:
a capability field, configured to identify an excess processing capability of said corresponding device for purposes of importing other functions from said one or more other devices in the network.

9. The apparatus as recited in claim 1, wherein said management data comprises one or more optional data fields, and wherein said one or more optional data fields comprise optional data that is required to perform said function.

10. The apparatus as recited in claim 1, wherein one or more of said plurality of the devices comprise sensing devices.

11. The apparatus as recited in claim 1, wherein one or more of said plurality of the devices comprise control devices.

12. The apparatus as recited in claim 1, wherein said descriptor data and said management data are disposed within messages that are transmitted over the network

13. A power management mechanism, for controlling the power consumed by devices within a network, said power management mechanism comprising:
power status logic, disposed within each of a plurality of the devices, configured to evaluate power status data for a corresponding device; and
remote control logic, disposed within said each of said plurality of the devices, coupled to said power status logic, and configured to export or import functions as directed.

14. The mechanism as recited in claim 13 wherein the network comprises a wireless network.

15. The mechanism as recited in claim 14, wherein the network is configured according to ZIGBEE standards.

16. The mechanism as recited in claim 13, wherein the network comprises a combination of wired and wireless devices.

17. The mechanism as recited in claim 13, wherein one or more of the devices comprises a service broker, and wherein said remote control logic within said service broker is configured to receive power management messages from other ones of said plurality of devices, and is configured to determine functions to distribute to selected devices, and is configured to generate power management messages to distribute said functions.

18. The mechanism as recited in claim 17, wherein said power management messages designate destination devices for performing designated ones of said functions.

19. The mechanism as recited in claim 13, wherein said power status logic comprises:
descriptor data, configured to identify an excess processing capability of said corresponding device for purposes of importing other functions from said one or more other devices in the network.

20. The mechanism as recited in claim 13, wherein said remote control logic comprises one or more optional data fields, and wherein said one or more optional data fields comprise optional data that is required to remotely perform a corresponding function.

21. The mechanism as recited in claim 13, wherein said power status data is disposed within messages that are transmitted over the network

22. A power management apparatus, for managing the power consumed by a network of devices, the apparatus comprising:
first power management logic, disposed within a service broker device, said service broker device comprising one of a plurality of the devices in the network, configured to provide for network-aware power management of the network of devices, said power management logic comprising:
descriptor data, said descriptor data having been received over the network, and identifying a power source for each of said plurality of devices in the network; and
management data, provided for transmission over the network, said management data identifying one or more functions for remote execution by one or more other devices in the network;
wherein said service broker device transmits messages over the network to distribute said one or more functions to said one or more other devices, thereby managing the power consumed.

23. The apparatus as recited in claim 22, wherein said service broker transmits a management message directing a destination device to perform one of said one or more functions, and wherein said management message comprises a portion of said management data.

24. The apparatus as recited in claim 22, further comprising:
second power management logic, disposed within a destination device, configured to enable said destination device to import said one or more functions for execution.

25. The apparatus as recited in claim 22, wherein said descriptor data comprises:
a capability field, configured to identify a excess processing capability of each of said one or more other devices.

26. The apparatus as recited in claim 22, wherein said management data comprises one or more optional data fields, and wherein said one or more optional data fields comprise optional data that is required to perform said one or more functions.

27. A method for exporting functions to optimize a power profile of a network of devices, the method comprising:
within each of a plurality of devices coupled to the network, evaluating a local power status and determining whether sufficient power is available to perform local functions;
for a first one of the plurality of devices, broadcasting a message over the network that indicates functions available for export;
determining that a second one of the plurality of devices can perform one or more of the functions; and
exporting the one or more of the functions for execution by the second one of the plurality of devices.

28. The method as recited in claim 27, wherein the network comprises a wireless network.

29. The method as recited in claim 27, wherein said determining is performed by a service broker that is coupled to the network of devices.

30. The method as recited in claim 27, wherein said exporting comprises:
transmitting a management message over the network that directs the second one of the plurality of devices to perform the one or more of the functions.

31. The method as recited in claim 27, further comprising:
for the second one of the plurality of devices, initially transmitting descriptor data over the network that identifies an excess processing capability.

32. The method as recited in claim 27, wherein said exporting comprises:
transmitting a management message over the network that directs the second one of the plurality of devices to perform the one or more of the functions; and
including in the management message, data that is required to perform the one or more of the functions.

33. A method for importing functions to optimize a power profile of a network of devices, the method comprising:
monitoring messages broadcast over the network to determine if one or more devices have insufficient power to perform certain functions;
evaluating a local power status and determining whether sufficient power and processing capabilities are available to perform the certain functions; and
in a destination device, importing one or more of the certain functions for execution.

34. The method as recited in claim 33, further comprising:
for a first one of the plurality of devices, broadcasting a message over the network that indicates the certain functions which are available for export.

35. The method as recited in claim 33, wherein the network comprises a wireless network.

36. The method as recited in claim 33, wherein said evaluating is performed by a service broker that is coupled to the network of devices.

37. The method as recited in claim 33, wherein said importing comprises:
via a service broker coupled to the network of devices, transmitting a management message over the network that directs the destination device to import the one or more of the certain functions.

38. The method as recited in claim 33, further comprising:
transmitting descriptor data over the network that identifies the certain functions which are available for export from the one or more devices

39. The method as recited in claim 33, wherein said importing comprises:
receiving a management message over the network that directs the destination device to perform the one or more of the certain functions; and
including in the management message, data that is required to perform the one or more of the certain functions.
